(19) United States
(12) Patent Application Publication
(10) Pub. No.: US 2011/0321024 A1
(43) Pub. Date: Dec. 29, 2011

(54) METHOD AND APPARATUS FOR UPDATING AN EXECUTING APPLICATION

(75) Inventors: Dennis Knothe, Burnaby (CA); Lawrence Tang, Burnaby (CA)

(73) Assignee: Nokia Corporation, Espoo (FI)

(21) Appl. No.: 12/824,950

(22) Filed: Jun. 28, 2010

(51) Int. Cl. G06F 9/44; G06F 3/048; G06F 3/14

(52) U.S. Cl. 717/168; 715/864

(57) ABSTRACT

An approach is provided for updating an application such as a widget. An update platform receives a request to update an application executing on a device. Execution of the application retrieves all or a portion of stored code associated with the application from a storage memory of the device and places the retrieved stored code as executing code in an execution memory of the device. The update platform determines whether updated code corresponding to the application is available based, at least in part, on the request and determines to retrieve the updated code if available. The update platform then determines to replace all or a portion of the stored code with the updated code without affecting the executing code.

### BACKGROUND

Wireless (e.g., cellular) service providers and device manufacturers are continually challenged to deliver value and convenience to consumers by, for example, providing compelling network services, applications, and content, as well as user-friendly devices. An important differentiator in this industry is the user interface. In particular, light-weight applications also widely known as widgets have emerged as a convenient means for presenting information and accessing services. These widgets provide basic components of graphical user interfaces (GUIs) for users to interact with applications, and enable more robust and user-friendly controls for user devices. However, as service providers, device manufacturers, and/or their developers add new functionalities, they face significant technical challenges to providing timely updates to the applications while still providing a good user experience (e.g., by not interrupting the user's operation of the application during updates).

### SOME EXAMPLE EMBODIMENTS

Therefore, there is a need for an approach for efficiently updating applications (e.g., widgets) that are executing on a device.

According to one embodiment, a method comprises receiving a request to update an application executing on a device. Execution of the application retrieves all or a portion of stored code associated with the application from a storage memory of the device and places the retrieved stored code as executing code in an execution memory of the device. The method also comprises determining whether updated code corresponding to the application is available based, at least in part, on the request. The method further comprises determining to retrieve the updated code if available. The method further comprises determining to replace all or a portion of the stored code with the updated code without affecting the executing code.

According to another embodiment, an apparatus comprising at least one processor, and at least one memory including computer program code for one or more computer programs, the at least one memory and the computer program code configured to, with the at least one processor, cause the apparatus to receive a request to update an application executing on a device. Execution of the application retrieves all or a portion of stored code associated with the application from a storage memory of the device and places the retrieved stored code as executing code in an execution memory of the device. The apparatus is also caused to determine whether updated code corresponding to the application is available based, at least in part, on the request. The apparatus is further caused to determine to retrieve the updated code if available. The apparatus is further caused to determine to replace all or a portion of the stored code with the updated code without affecting the executing code.

According to another embodiment, a computer-readable storage medium carrying one or more sequences of one or more instructions which, when executed by one or more processors, cause an apparatus to receive a request to update an application executing on a device. Execution of the application retrieves all or a portion of stored code associated with the application from a storage memory of the device and places the retrieved stored code as executing code in an execution memory of the device. The apparatus is also caused to determine whether updated code corresponding to the application is available based, at least in part, on the request. The apparatus is further caused to determine to retrieve the updated code if available. The apparatus is further caused to determine to replace all or a portion of the stored code with the updated code without affecting the executing code.

According to yet another embodiment, an apparatus comprises means for receiving a request to update an application executing on a device. Execution of the application retrieves all or a portion of stored code associated with the application from a storage memory of the device and places the retrieved stored code as executing code in an execution memory of the device. The apparatus also comprises means for determining whether updated code corresponding to the application is available based, at least in part, on the request. The apparatus further comprises means for determining to retrieve the updated code if available. The apparatus further comprises means for determining to replace all or a portion of the stored code with the updated code without affecting the executing code.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of updating executing applications, e.g., widgets, according to one embodiment;

FIG. 2 is a diagram of the components of an update platform, according to one embodiment;

FIG. 3 is a flowchart of a process for updating an executing application, according to one embodiment;

FIG. 4 is a flowchart of a process for canceling an application update, according to one embodiment;

FIG. 5 is a time sequence diagram that illustrates a sequence of messages and processes for instantiating an update service, according to one embodiment;

FIG. 6 is a time sequence diagram that illustrates a sequence of messages and processes for initializing an update service, according to one embodiment;

FIGS. 7A-7C are time sequence diagrams that illustrate a sequence of messages and processes for downloading and updating an executing application, according to one embodiment;

FIGS. 8A and 8B are diagrams a user interface utilized in the processes for updating an application, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile station (e.g., handset) that can be used to implement an embodiment of the invention.

### DESCRIPTION OF SOME EMBODIMENTS

A method and apparatus for updating an executing application (e.g., a web application, widget, etc.) are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to widgets, it is contemplated that the approach described herein may be used with other applications that are executed on a device. As used herein, the term “widget” is a light-weight application (e.g., a web application) based on standard web technologies (e.g., web runtime (WRT)—a web application runtime environment included in many browsers), that serves as a frontend or client to web-based or other content and services. By way of example, a widget may be based on standards developed by the World Wide Web Consortium (W3C) Web Applications Working Group.

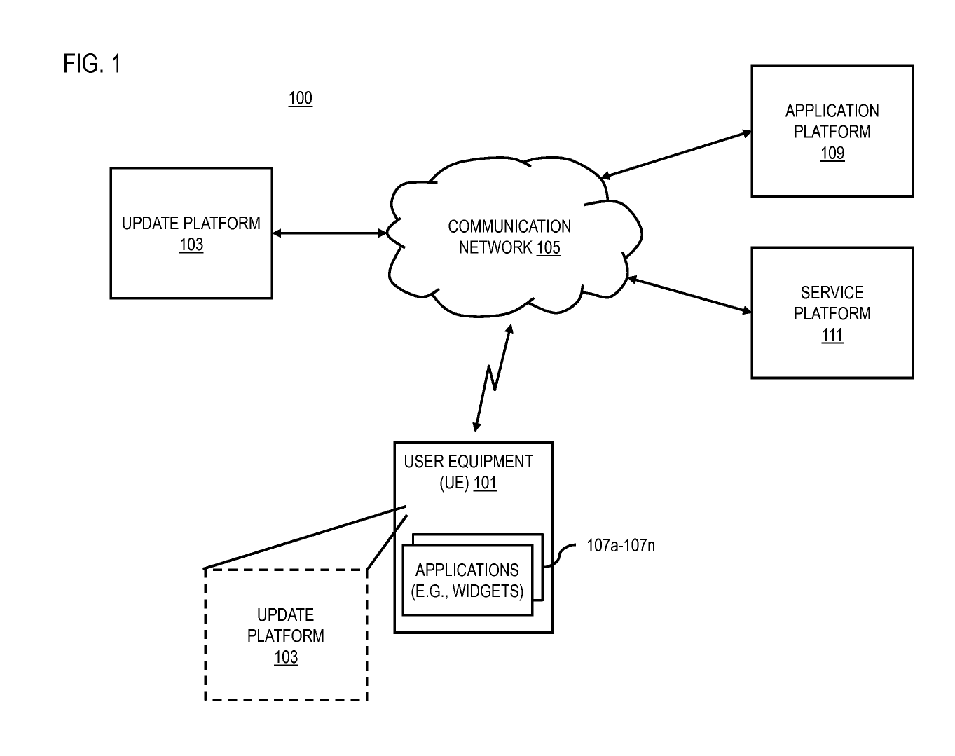

FIG. 1 is a diagram of a system capable of updating an executing application, e.g., a widget, according to one embodiment. Service providers and developers often provide updates to existing applications or widgets to add, for instance, new features, fix errors, increase security, and the like. However, these updates historically have come at the expense of user experience. For example, a traditional update often requires a user to stop using an application as the application is being updated, thereby denying the user access to the application until the update is complete. Moreover, a user is often alerted of an available update when the user accesses the particular application or widget for use. Therefore, the user typically has to delay use or operation of the application for a period of time, which can degrade the application's user experience and discourage use of the application.

To address this problem, the system 100 introduces the capability to enable an executing widget to update and refresh itself without closing and/or restarting the application. More specifically, when an application (e.g., a web application) is executed on a particular device (e.g., a smartphone, tablet, etc.), the system 100 via the device loads the all or a portion of the code and associated files (e.g., WRT files) into an execution memory (e.g., random access memory (RAM)) from, for instance, a storage memory (e.g., flash memory, disk storage, read only memory (ROM)), etc.). The execution of the application is then supported by the files or code in the execution memory rather than the storage memory. The system 100 can then determine whether there is an available update for the application. If an update is available, the system 100 retrieves the updated code and replaces the corresponding code of the application in the storage memory without disturbing or affecting the application code (e.g., the executing code) in the execution memory. In this way, the application can continue to execute on the device despite the update to the application as stored in the device's storage memory.

As shown in FIG. 1, the system 100 comprises at least one user equipment (UE) 101 having connectivity to an update platform 103 via a communication network 105. For the sake of simplicity, only one UE 101 is depicted in FIG. 1. However, it is contemplated that the system 100 can support any number of UEs 101 to perform the updating approach as described herein. The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In addition, the UE 101 can support execution of one or more applications 107a-107n (e.g., web applications, widgets, etc.). According to one embodiment, the applications 107a-107n can be supplied by and/or operate in conjunction with an application platform 109 and/or service platform 111. By way of example, the application platform 109 can be an online application store (e.g., Nokia's Ovi Store) to provide a selection of applications for download to the UE 101. Similarly, the service platform 111 can provide applications (e.g., client applications) that support any of the services available from the platform 111 (e.g., music service, mapping service, video service, social networking service, content broadcasting service, etc.). For example, the applications or widgets 107a-107n can be downloaded at the request of the user, or alternatively, be delivered based on a service operated by a service provider. An application or widget 107 can thus be regarded in some respects as a user interface element, and can be downloadable and support software that provides a variety of content information, e.g., news, stock quotes, weather forecasts, maps, location information, advertisement, calendars, calendar information, contact information, messages, emails, service guide information, recommendations, audio files, video files, radio/television broadcasting, etc. A widget may be configured to continuously receive content information, such as continuously updated content, from one or more sources.

In one embodiment, the application platform 109 and/or the service platform 111 may at times (e.g., periodically) make application updates available to the UE 101 via, for instance, the update platform 103 or directly to the UE 101. In certain embodiments, the applications or widgets 107a-107n are authored so that they can check whether updates are available. In yet another embodiment, the update platform 103 can check for updates on behalf of the applications 107a-107n. The update platform 103 can then initiate the application update process as described herein. Although shown as a standalone component, it is contemplated that the update framework 103 can be deployed within the UE 101, the application 107 itself, the application platform 109, the service platform 111, or any other component of the system 100.

As previously noted, the update platform 103 enables the updating of an application that is currently executing on the UE 101 without affecting the execution state of the application (e.g., the application need not be stopped or restarted for the application update to occur). This capability enables the application to continue running independently of the updating process by, for instance, updating the application code in the storage memory of the device separately from the application code placed in the execution memory of the device that supports executing the application.

In one embodiment, on initiation of an update, the update platform 103 need not display a status dialog box, prompt, or other similar user interface element to indicate that an update is in progress. Instead, the update platform 103 can pass or transmit status information regarding the update to the application 107. The application 107 can then determine on its own what actions to take (if any) in response to the update. For example, when the status information indicates that the update has been completed successfully, the application 107 may initiate a reload of itself from the stored code in the device's storage memory. In this case, reload of the application 107 removes the applications executing code from the execution memory and then loads the updated code into the execution memory to initiate execution of the application using the updated code. Alternatively, the application 107 may choose to ignore the update and continue running until the user terminates the application. On a subsequent launch or execution of the application, the updated code would be used for execution.

In another embodiment, the application 107 may supply resource location information (e.g., a Universal Resource Location (URL)) for downloading the update or determining whether an update is available. In some cases, when the application 107 supplies the resource location information for the update, the update platform 103 can ignore the default update location (e.g., a default URL in the config.xml file of a web-based widget application 107). In certain embodiments, the resource location information may be validated by, for instance, the update platform 103, the application 107, or other component of the network (e.g., application platform 109, service platform 109, etc.) before use.

In yet another embodiment, once the update process has been started by the update platform 103, a request to cancel the update can be made to the application 107, a user of the UE 101, service operator, and/or the like. Whether the cancel operation is successful or not depends on for instance the status or stage of the update, availability of back-up files, contents of the execution memory or storage memory, etc. For example, if the stored code of the application has already been overwritten with the updated code in the storage memory, the cancel operation generally cannot be completed successfully. However, in certain embodiments, even if the stored code as been overwritten, the update platform 103 can restore the overwritten code using the application code stored in the execution memory.

In another embodiment, the request to update may specify the application 107 to update using registration information (e.g., an identifier associated with the application 107). In this way, the update platform 103 can support updating of the application 107 even when the application 107 is embedded or nested in another application. In some embodiments, the registration information of the application 107 can be used to verify that the application is registered on the system 100 or UE 101 to determine update eligibility.

In another embodiment, the update platform 103 may initiate either a partial (e.g., a delta) or a full update of the application 107. More specifically, a partial or delta update applies to, for instance, only those portions of the stored code that has been changed in the update. In this way, the update platform 103 need only download those portions of the code that have changed.

In embodiments in which the application 107 is a standards-compliant web application (e.g., a W3C compliant web application), the update platform 103 may provide for extensions to the standards to aid in updating the widget. By way of example, the update platform 103 can define a new XML-based namespace and element. It is noted that the namespace and element are optional. In other words, a widget application 107 may still update itself without these extensions. The new namespace “xmlns:services” and corresponding element “<services:server> can be added to the config.xml file associated with the widget application 107. An example config.xml of a full update widget, with the extension namespace “xmlns:services” is defined and the new element is defined under the extension namespace as shown in Table 1 below.

TABLE 1

<?xml version=“1.0” encoding=“UTF-8”?>
<widget xmlns=“http://www.w3.org/ns/widgets”
xmlns:services=“http://www.ovi.com/services”
id=“com.webappupdatewgtA.widget” version=“1.1” height=“”
width=“” xml:lang=“”>
<name>Web Application Update wgt A</name>
<services:server>http://update.company.com/update.php?id=
com.webappupdatewgtA.widget&amp;version=1.0&amp;
type=wgt</services:server>
<content src=“main.html”/>
</widget>

In one embodiment, for a partial update, the tag “<services:delta version=“1.0”/> can be used to designate portions of the application 107 to update.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UE 101, the update platform 103, the application platform 109, and the service platform 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 107, the application platform 108, and/or the service platform 111 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

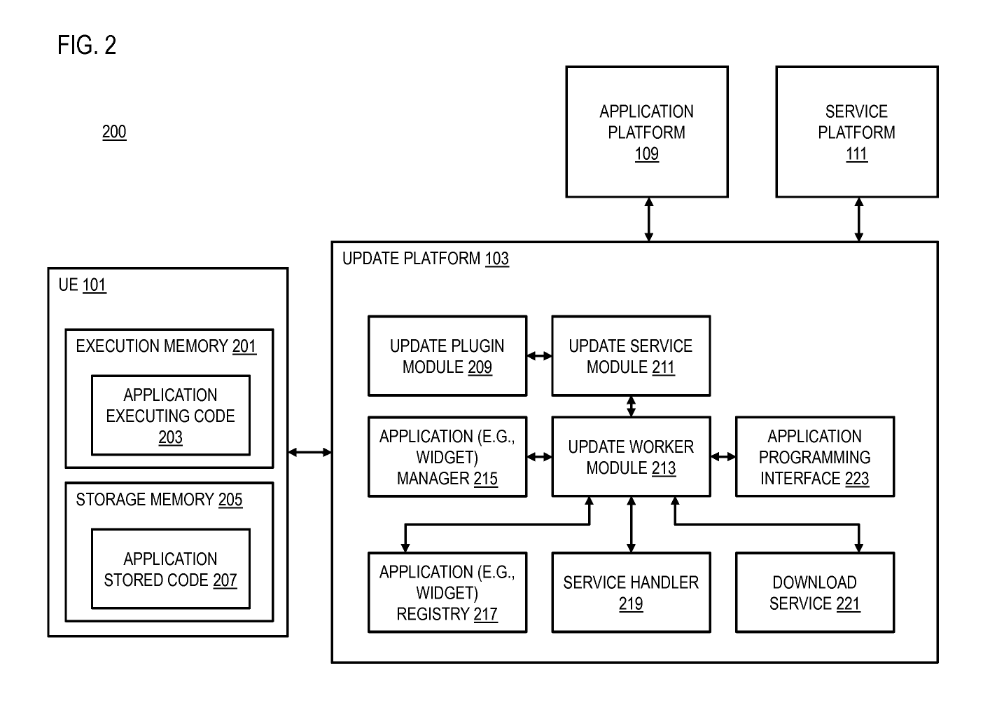

FIG. 2 is a diagram of the components of the update platform 103, according to one embodiment. By way of example, the update platform 103 includes one or more components for bridging communication sessions among multiple devices. It is contemplated that the functions of these components may be combined in one or more components or performed by other components of equivalent functionality. As shown in FIG. 2 and as described with respect to FIG. 1, the update platform 103 interacts with the UE 101 that executes an application 107 (not shown in FIG. 2). In this example, the on execution of the application 107, the UE 101 places in its execution memory 201 (e.g., RAM) the application executing code 203 (e.g., code and associated files) for executing the application 107. By way of example, the application 107 is a web application (e.g., WRT application) executing via, for instance, a web runtime engine (e.g., the opensource WebKit engine) on the UE 101. The executing code 203 is loaded from the storage memory 205 (e.g., flash memory, disk memory, etc.) and copied from the application stored code 207. In this way, the UE 101 maintains an execution memory 201 containing the application executing code 203 from which the application 107 executes, and a separate storage memory 205 containing the application stored code 207. In one embodiment, during non-update processes, the executing code 203 and the stored code 207 are substantially identical.

The update platform 103 also has connectivity to the application platform 109 and the service platform 111. In one embodiment, the update platform 103 can periodically or manually check the application platform 109 and the service platform 111 for updates to the applications resident in the UE 101. In addition or alternatively, the application platform 109 and/or the service platform 111 may send or push notifications of available updates to the update application platform 103, the application 107, and/or the UE 101. In some embodiments, the application platform 109 and/or the service platform 111 host the updated code corresponding to applications 107 that are executing on the UE 101. In other embodiments, the application platform 109 and/or the service platform 111 contain pointers (e.g., resource location information such as a URL) to the network 105 resources containing updated code.

In one embodiment, the update platform 103 includes an update plugin module 209 that serves as the interface between the application 107 executing on the UE 110 and the update platform 103. In one embodiment, the update plugin module 209 provides procedures or routines for the application 107 to invoke the update service module 211 that can instantiate instances of the update service module 211 for performing the update process. The update service module 211 also provides feedback and status updates of the update process to the application 107. For example, the application 107 can initiate the update process by sending an update request to the update platform 103 through the update plugin module 209. The request is then relayed to the update service module 211 to activate related update modules.

In turn, the update service module 211 interacts with the update worker module 213 to coordinate and perform the update process. The update worker module 213 has connectivity to the application (e.g., widget) manager 215 that is responsible for installing applications/updates and monitoring current application installations. As used herein, the term “applications” includes widgets and other similar lightweight applications executing on the UE 101. To assist with this monitoring, the application manager 215 has access to an application registry 217. The application registry 217 provides a listing of applications (e.g., widgets) that are installed or executing on the UE 101. In one embodiment, the application registry 217 identifies registered applications 107 using identifiers. In this way, update requests and messages can use the identifier for consistent and quick reference.

On verification of the registration status of the application 107 specified in the update request, the update worker module 213 can determine whether there are any available updates. Once an update is identified, the update worker module 213 directs the service handler 219 to initiate or create a new service session for use by the download service 221 to retrieve the updated code, application, and/or related files.

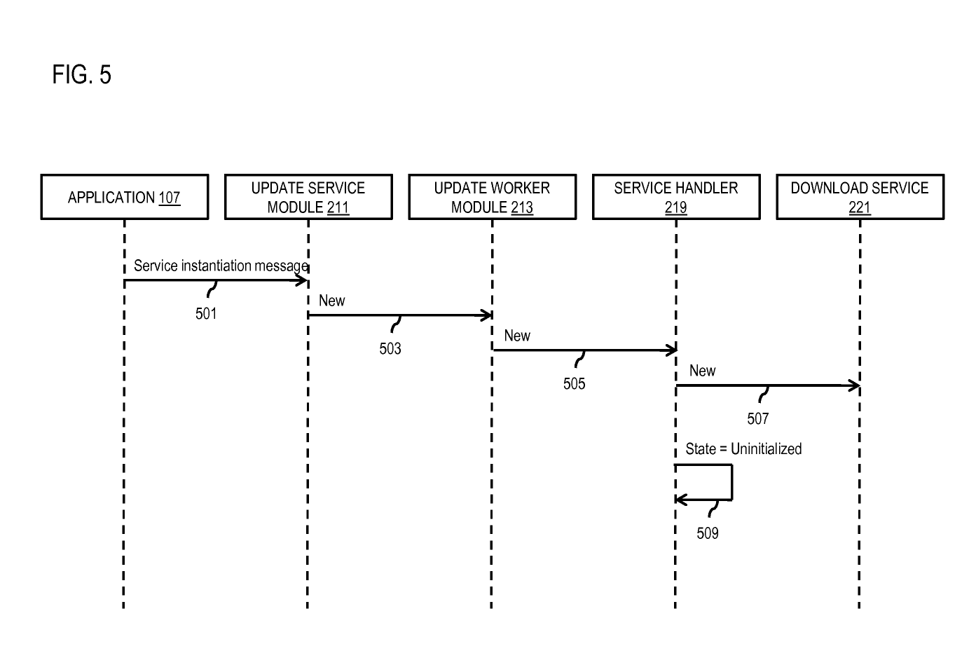

In one embodiment, the update platform 103 also has an application programming interface (API) 223 in addition or as an alternate to update plugin module 209. By way of example, the API 223 defines routines, data structures, procedures, protocols, and the like that the application 107 or other network 105 component can use to direct the update functions of the platform 103. The interaction and functions of the components of the update platform 103 are described in more detail with respect to FIGS. 5, 6, and 7A-7C.

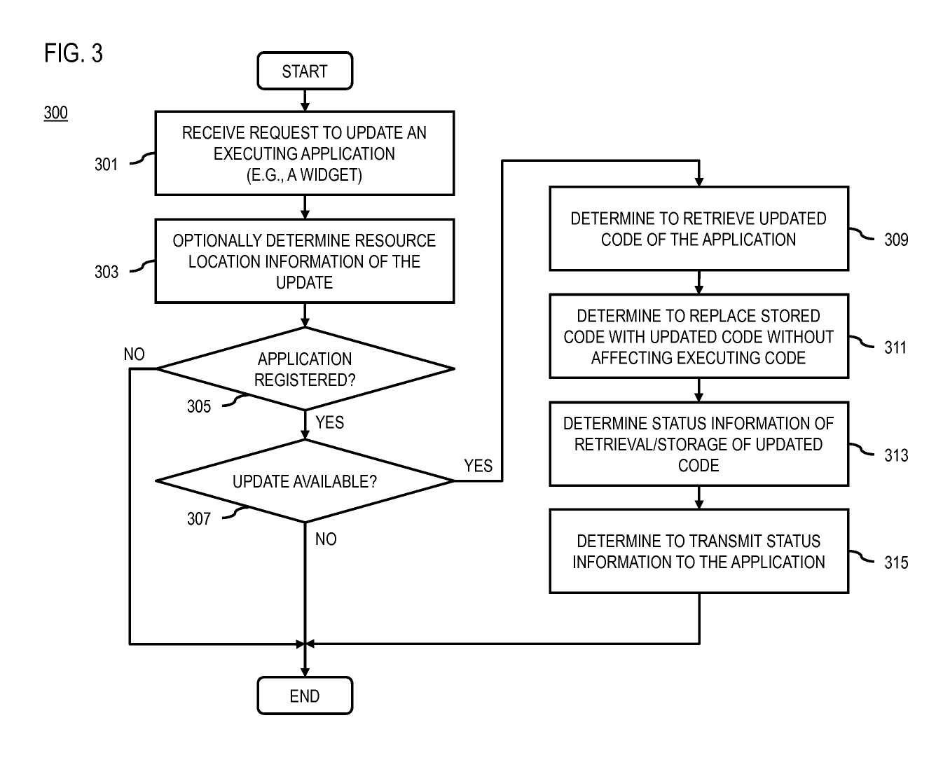

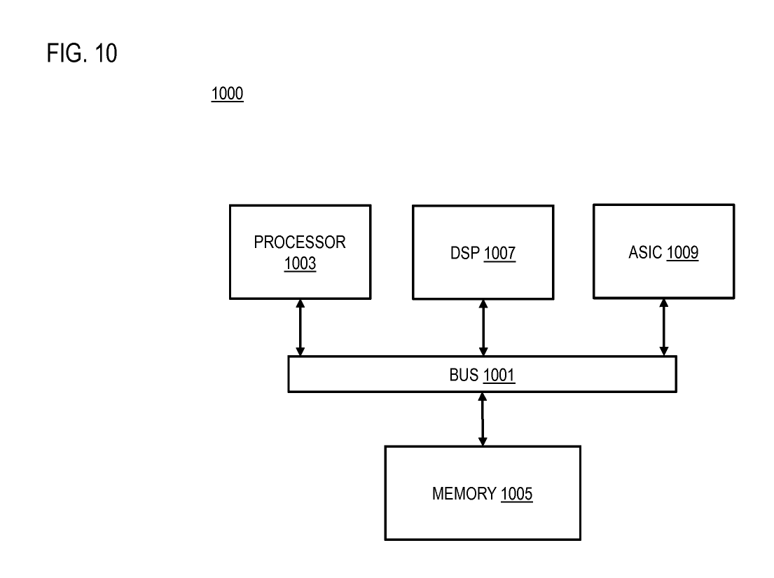

FIG. 3 is a flowchart of a process for updating an executing application, according to one embodiment. In one embodiment, the update platform 103 performs the process 300 and is implemented in, for instance, a chip set including a processor and a memory as shown in FIG. 10. In step 301, the update platform 103 receives a request to update an application 107 (e.g., a widget) executing on the UE 101. In one embodiment, the request may be made explicitly by the application 107, the UE 101, a user associated with the UE 101, or similar entity. In addition, the request may be initiated by a notification from the application platform 109 and/or the service platform 111 that an application update is available. As noted previously, execution of the application 107 retrieves all or a portion of the stored code 207 associated with the application 107 from a storage memory 205 of the UE 101 and places the retrieved stored code 207 as executing code 203 in an execution memory 201 of the UE 101. In other words, on execution of the application 107, all of the files associated with executing the application 107 are loaded from the storage memory 205 to the execution memory 201. The application 107 is then executed from the execution memory 201.

In step 303, the update platform 103 optionally determines the resource location information of the updated content for the application 107. In one embodiment, the resource location information can be determined from the executing code 203, the stored code 207, an update service (e.g., the update platform 103, the service platform 111), an application provider (e.g., the application platform 109), or a combination thereof. For example, the executing code 203 and/or the stored code 207 may include default values specifying a network location for checking updates. In addition or alternatively, the application 107 may determine and/or specify the resource location information. If the application 107 makes such a specification, the corresponding resource location information can be used in place of the default values. As previously noted, it is contemplated that any component accessible over the communication network 105 can served as a host for the update information.

Next, the update platform 103 determines registration information for the application 107 (step 305). The registration information is maintained in, for instance, the application registry 117 and serves to verify that the application 107 has been properly installed and available for updating. Registration of the application 107 also can help to minimize the potential for malicious installation of unwanted and/or unrequested applications on the UE 101. If the application 107 is not registered, the process ends and no update is performed.

If the application is registered, the update platform 103 determines whether updated code corresponding to the application is available based, at least in part, on the request (step 307). By way of example, the update platform 103 may query the application platform 109 and/or the service platform 111 for update information. If the resource location information was provided or otherwise determined as described with respect to step 303, the update platform 103 can also check for updates using the resource location information (e.g., a URL of an update). If an update is not available, then the process ends. Otherwise, the update platform 103 determines to retrieve or download the updated application or the updated code of the application (step 309). As noted previously, the update may be either a partial or a full update of the application.

After retrieving the updated code, the update platform 103 determines to replace all or a portion of the stored code with the updated code without affecting the executing code of the application 107 (step 311). Because the application 107 is executing directly from execution memory 203, changes or updates to the stored code in the storage memory 205 have no direct effect on the execution status of the application 107.

In one embodiment, during the retrieval and/or replacement of the stored code with the updated code, the update platform 103 can determine the update status periodically (step 313). In some embodiments, the status information may be transmitted to the update platform 103 without active determination by the update platform 103. Then, the update platform 103 transmits or otherwise reports the status information to the application 107 (step 315). In the approach described herein, the choice of how to respond to the update is left to the discretion of the application 107. For example, the application 107 can continue to be executed and then can determine an appropriate response to the update based, at least in part, on the execution. Alternatively, following the update, the application 107 can continue to execute according to the executing code until a restart of the application, generate a notification of the update for presentation at the device, provide no response, or a combination thereof.

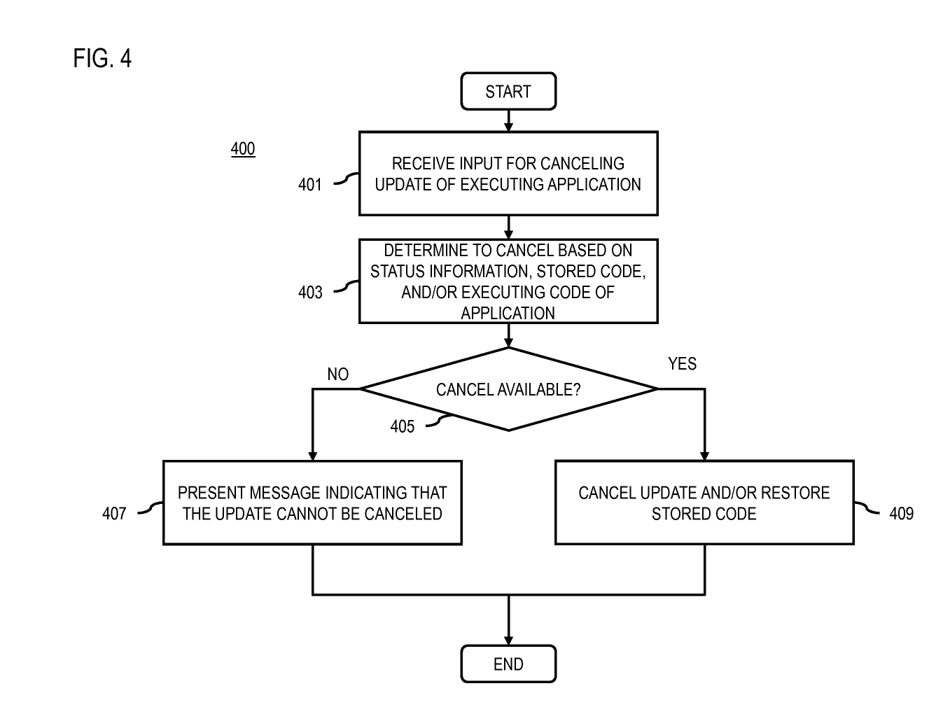

FIG. 4 is a flowchart of a process for canceling an update process, according to one embodiment. In one embodiment, the update platform 103 performs the process 400 and is implemented in, for instance, a chip set including a processor and a memory as shown in FIG. 10. The process 400 assumes that the update platform 103 has initiated an update of an application according to, for instance, the process 300 of FIG. 3. In step 401, the update platform 103 receives an input for canceling an update currently in progress. The update platform 103 then determines to cancel the update based, at least in part, on the status information related to the update, the stored code, the executing code, or a combination thereof. For example, the update platform 103 may review to what extent the stored code has already been updated and whether the updated portion is reversible. The update platform 103 may also determine whether the execution code can be used to restore the former stored code of the application.

From this information, the update platform 103 determines whether the option to cancel is available (step 405). If the option is not available, the update platform 103 presents a message indicating that the update cannot be canceled (step 407). If the cancel option is available, the update platform 103 cancels the update and/or attempts to restore the previously stored code (step 409). In one embodiment, if available, the executing code may be used to restore the originally stored code.

FIG. 5 is a time sequence diagram that illustrates a sequence of messages and processes for instantiating an update service, according to one embodiment. A network process on the network is represented by a dotted vertical line. A message passed from one process to another is represented by horizontal arrows. A step performed by a process is indicated by the text. The processes represented in FIG. 5 are an application (e.g., widget) 107, an update service module 211, an update worker module 213, a service handler 219, and a download service 221.

The service instantiation process of FIG. 5 represents the initials steps of readying the update process by loading or instantiating service components. FIG. 5 is explained using pseudocode based on JavaScript, but it is contemplated that any computer instruction language and/or protocol may be used with the approach described herein. At 501, the application 107 initiates the instantiation of the update service by sending a service instantiation message (e.g., a “getServiceObject( )” message or other like message) to the update service module 211. As shown, the request 501 causes a cascade of services and modules to load. For example, the update service module 211 directs the update worker module 213 to load and create a new instance 503 to support the request. In turn, the update worker module 213 sends a command 505 to load and create a new instance of the service handler 219. Next, the service handler 219 directs the download service 221 to load and prepare the download service 221 to receive requests to download subsequent updates via a message 507. On loading of the modules, the service handler 219 enters into an idle state 509 and awaits further directions.

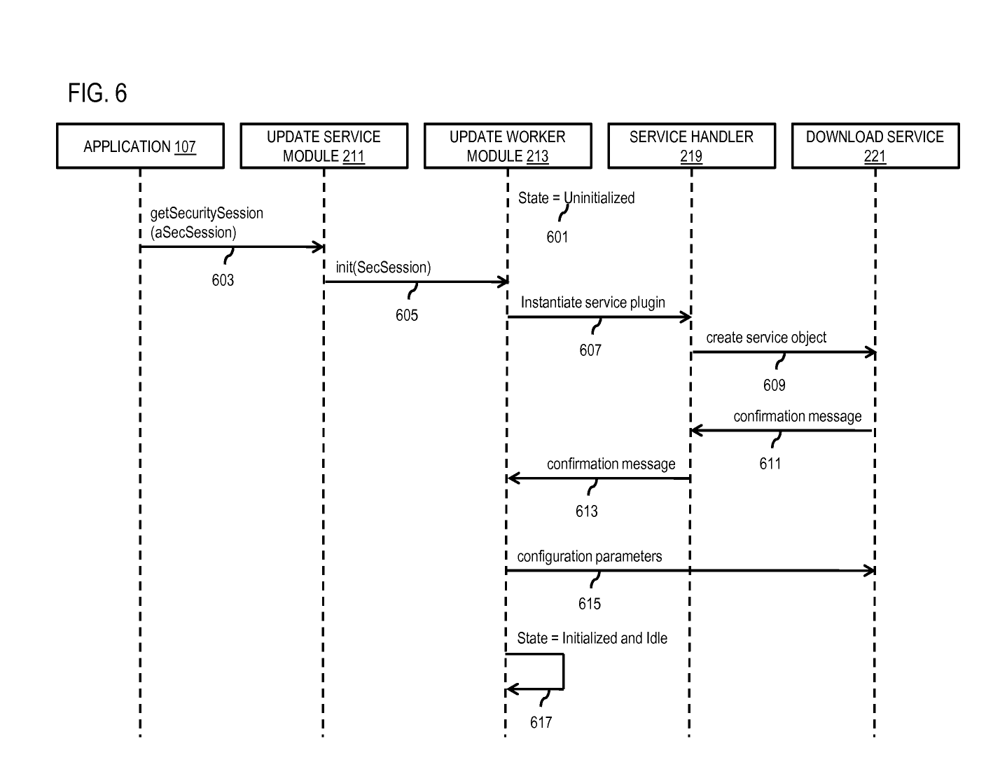

FIG. 6 is a time sequence diagram that illustrates a sequence of messages and processes for initializing an update service, according to one embodiment. A network process on the network is represented by a dotted vertical line. A message passed from one process to another is represented by horizontal arrows. A step performed by a process is indicated by the text. The processes represented in FIG. 6 are an application (e.g., widget) 107, an update service module 211, an update worker module 213, a service handler 219, and a download service 221.

The steps of FIG. 6 follow after the service instantiation process of FIG. 5. FIG. 6 is explained using pseudocode based on JavaScript, but it is contemplated that any computer instruction language and/or protocol may be used with the approach described herein. At 601, the update worker module 213 and the other processes begin in a loaded (i.e., instantiated) but uninitialized state 601. At 603, the application 107 begins the initialization process by requesting a security session from the update service module 211 using the “getSecuritySession(aSecSession)” command. In response, the updates service module 211 directs the update worker module 213 to initialize the security session using the command 605 “init(SecSession)”. In some embodiments, it is contemplated that a security session need not be requested, and that the application 107 need only request that the service update service module 211 and or update worker module 213 be initialized. The worker module 213 then requests an interface from the service handler 219 via the request 607 to create a service object 609 with the download service 221 (e.g., instantiate the service plugin for the download service 221). By way of example, the service object 609 can be used subsequently to initiate update download sessions from the application platform 109, the service platform 111, or other network 105 component.

On creating the service object 109, the download service 211 sends a confirmation message 611 regarding the initialization to the service handler 219, which then relays the message as a confirmation message 613 to the update worker module 213. Based on the confirmation message 613, the update worker module 213 can transmit configuration parameters 615 to the download service 221. By way of example, the configuration parameters include setting parallel vs. sequential download, status reporting requirements (e.g., report every 10% completed download, etc.), and the like. The update worker module then enters an initialized but idle state 617 to await an update request.

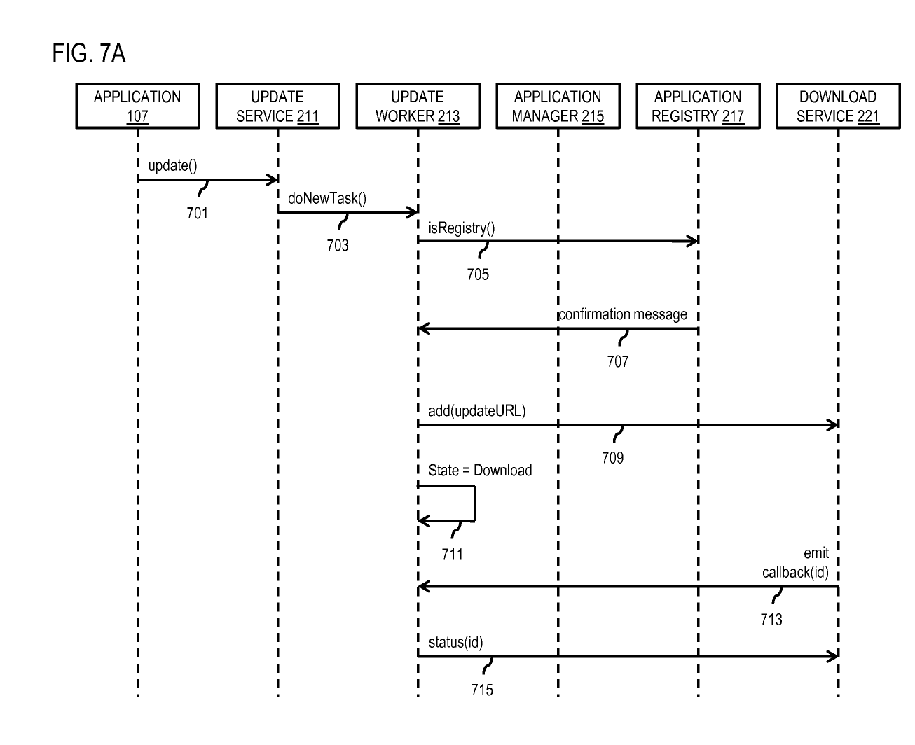

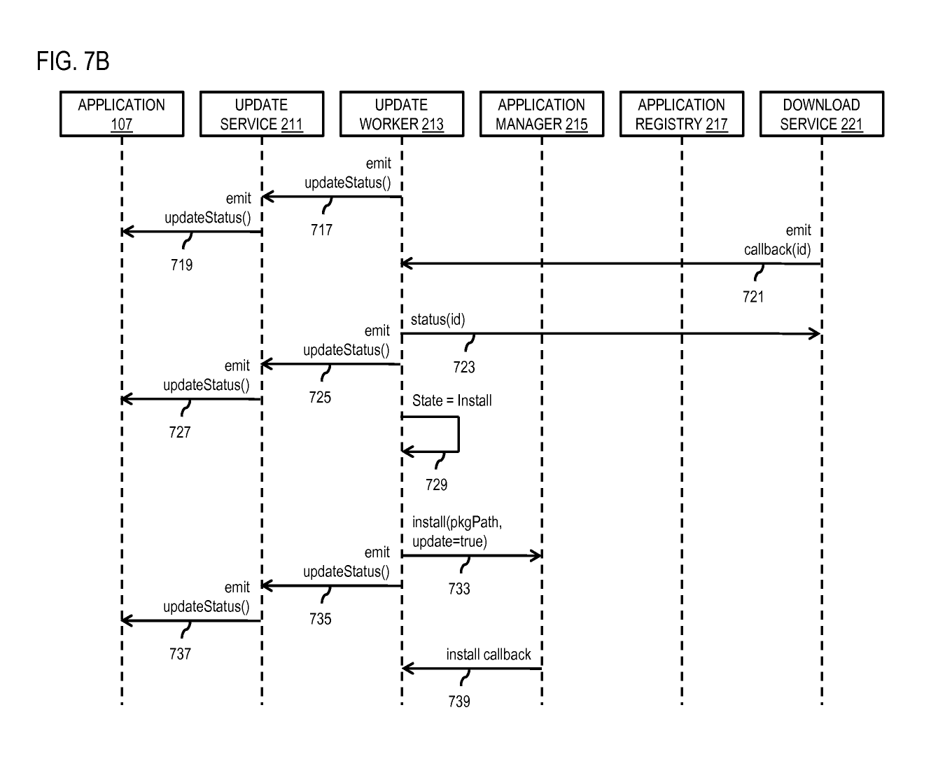

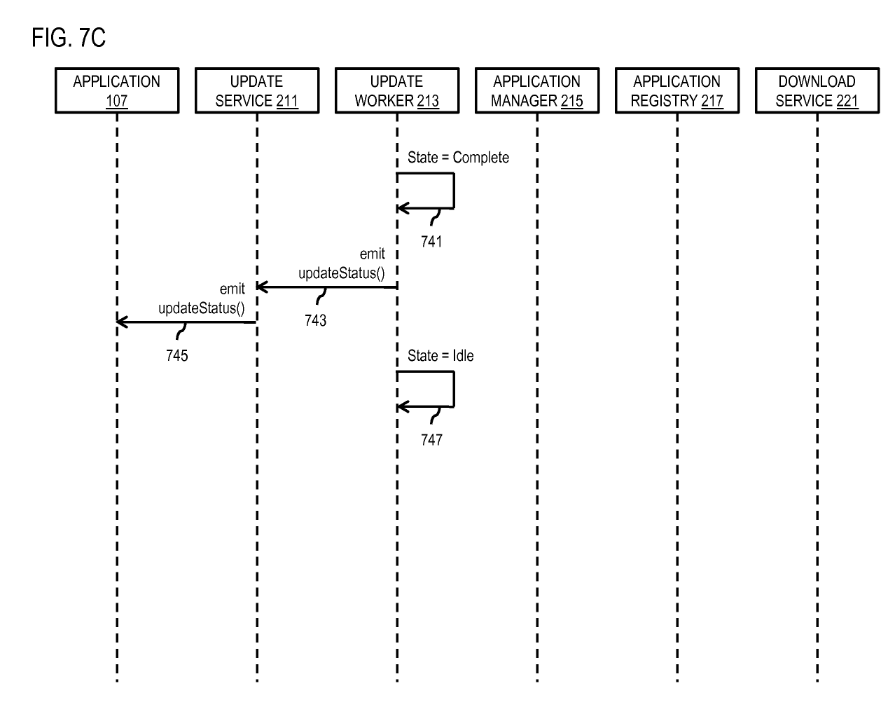

FIGS. 7A-7C are time sequence diagrams that illustrate a sequence of messages and processes for downloading and updating an executing application, according to one embodiment. A network process on the network is represented by a dotted vertical line. A message passed from one process to another is represented by horizontal arrows. A step performed by a process is indicated by the text. The processes represented in FIGS. 7A-7C are an application (e.g., widget) 107, an update service module 211, an update worker module 213, application manager 215, application registry 217, a service handler 219, and a download service 221. The sequence of messages and processes for downloading and updating an executing application span the

FIGS. 7A-7C are explained using pseudocode based on JavaScript, but it is contemplated that any computer instruction language and/or protocol may be used with the approach described herein. At 701, the application 107 sends an update request 701 “updated” to a previously initialized update service module 211. As noted previously, the update request 701 may identify the application 107 to update using a numeric identifier or other label to uniquely identify the application 107. In response, the update service module 211 sends a command 703 “doNewTask( )” to the update worker module 213 conveying the update request. In this example, the command 703 also includes the application 107 identifier, thereby enabling the update worker determine whether the identified application 107 is registered with the application registry 217. If there registry 217 contains the registration information for the application 107, the registry 217 transmits a confirmation message 707 to the update worker module 213.

The update worker module 213 then determines the resource location information (e.g., URL) for the updated application. As described previously, the resource location information can be obtained from a default entry specified in the application 107 or can be dynamically determined by the application 107. The update worker module 213 then transmits the resource location information to the download service 221 via a message 709 “add(updateURL)” to begin download of the update by the download service 221. At the same time, the update worker module 213 changes its state to indicate that an update download is progress. During the download, the download service 221 and the update worker exchange status messages 713 and 715 to monitor download progress.

Continuing to FIG. 7B, the update worker module 213 relays the status message from the download service 221 to the update service module 211, which in turn, provides the status to the application 107. Because the application 107 continues to run independently during the update process, the application 107 can decide on its own what, if any, response it should make with respect to the update. When the download is complete, the download service 221 alerts the update worker module 213 via a message 721. The update worker module 213 confirms the message 721 with a status message 723 to the download service 221. The update worker module 213 also relays the message regarding the completed download to the update service 211 via a message 725, which is forwarded to the application 107 as message 727.

At the same time the update worker module 107 changes its state to “install” and directs the application manager 215 to install the download updated in a message 733. The installation status is then relayed from the update worker module 213 to the update service 211 via a message 735 and then to the application 107 via a message 737. On completion of the installation of the update, the application manager 215 transmits a status message 739 to the update worker module 211.

Continuing to FIG. 7C, the update worker module changes its state from “install” to “complete” to indicate that the update has been installed. By way of example, the application manager 215 installs the application to the storage memory of the UE 101 executing the application 107 so that the execution of the application 107 remains undisturbed by the update process. Once again, the update worker module 213 relays the completed update message 743 to the update service module 211 and then to the application 107 via the message 745. The update worker module 213 then returns to an idle state 747 to await the next update.

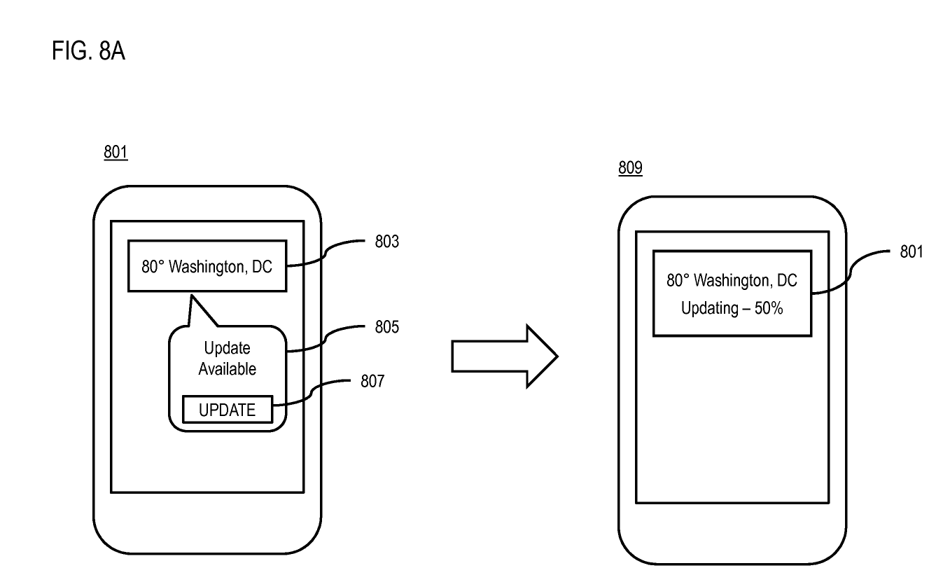

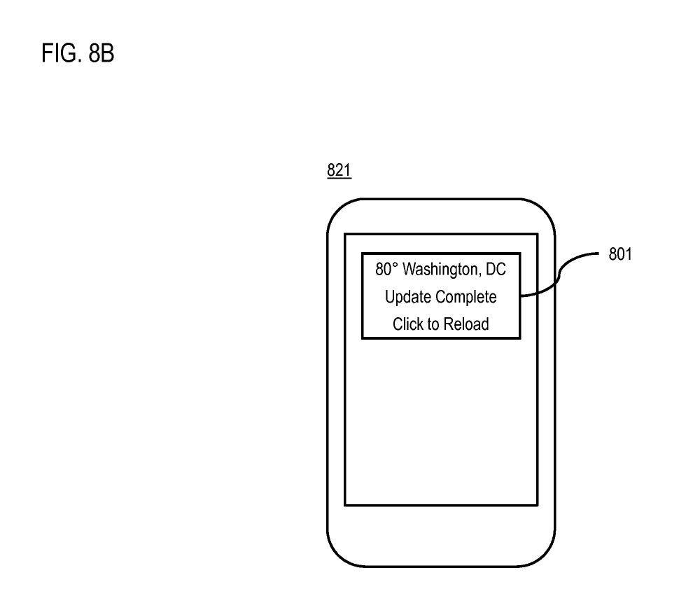

FIGS. 8A and 8B are diagrams a user interface utilized in the processes for updating an application, according to various embodiments. User interface 801 of FIG. 8A depicts a UE 101 (e.g., a smartphone) executing a widget 803 for displaying the current weather. In one embodiment, on executing the widget 801, the widget 801 initiates a check for updates and displays a message 805 indicating that an update is available. The user can initiate a manual update by selecting the update button 807. In other embodiments, the widget 801 need not display an update message and may proceed to automatically update the widget 801 in the background.

In this example, the user selects the manual update option 807 to initiate the update process as described herein. As depicted in user interface 809, the widget 801 continues to execute and function to display weather information. At the same time, widget displays the progress of the update (e.g., progress is at 50%). On completion of the update, the widget 801 in user interface 821 displays a message that the update has been completed and gives the user the option to reload the widget to view the updated widget. Through the entire update process the widget continues to function. If the user chooses not to immediately reload the widget, the widget will continue to operate using the original executing code.

The processes described herein for updating an executing application (e.g., a widget) may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

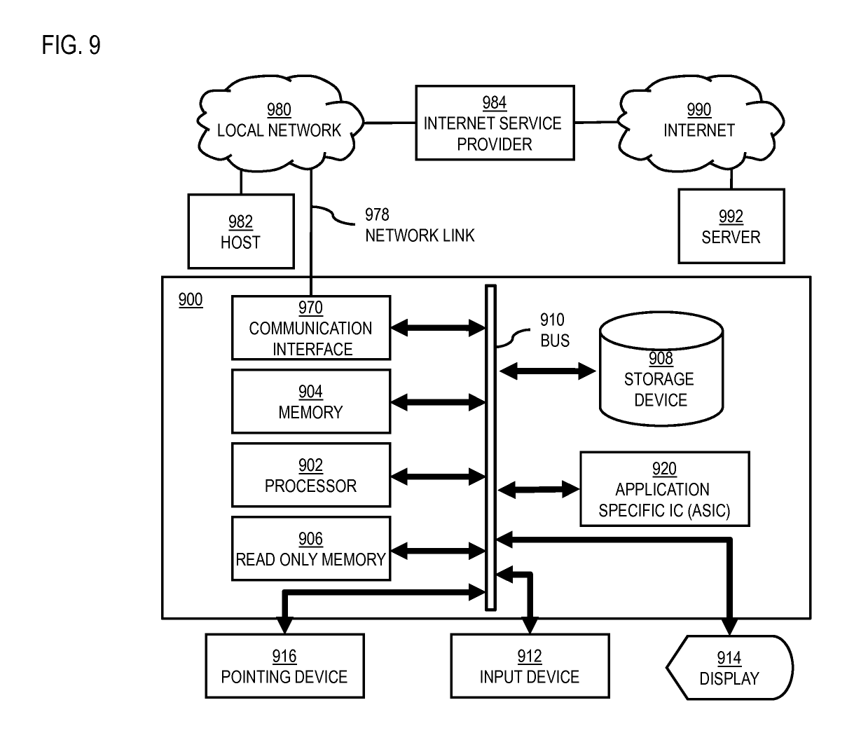

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to update an application as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of updating an application.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to updating an application. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for updating an application. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for updating an application, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for updating an application.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to update an application as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of updating an application.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to update an application. The memory 1005 also stores the data associated with or generated by the execution of the inventive steps.

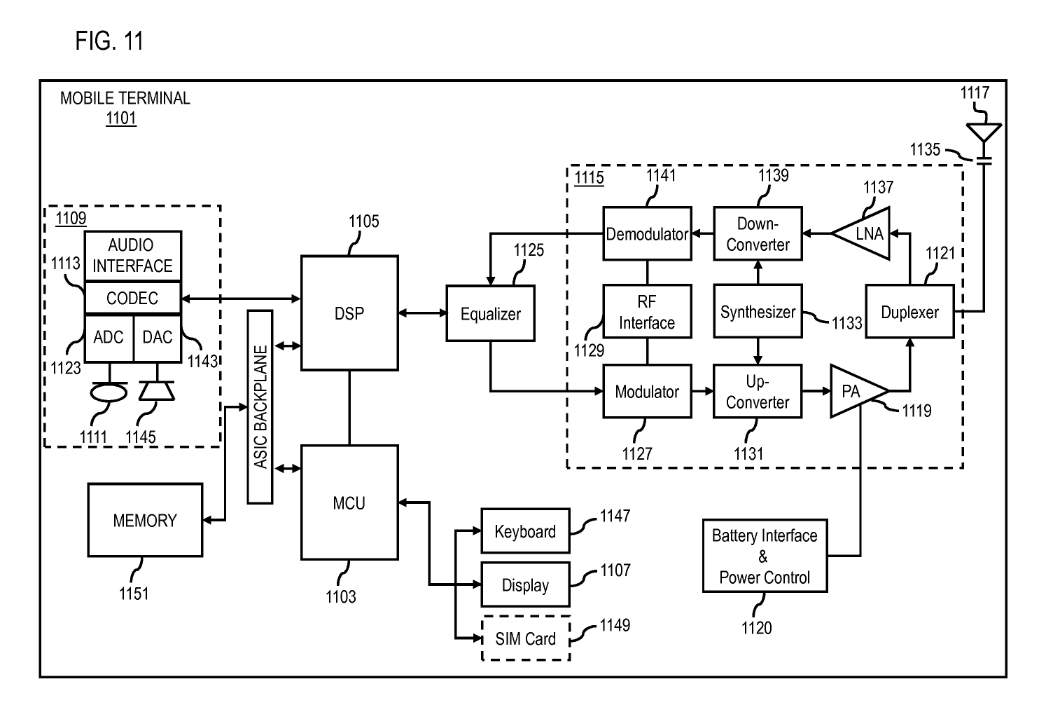

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of updating an application. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of updating an application. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to update an application. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving a request to update an application executing on a device, wherein execution of the application retrieves all or a portion of stored code associated with the application from a storage memory of the device and places the retrieved stored code as executing code in an execution memory of the device;
determining whether updated code corresponding to the application is available based, at least in part, on the request;
determining to retrieve the updated code if available; and
determining to replace all or a portion of the stored code with the updated code without affecting the executing code.

2. A method of claim 1, wherein the application continues executing based, at least in part, on the executing code and determines a response to the update.

3. A method of claim 2, wherein the response includes continuing to execute according to the executing code until a restart of the application, generating a notification of the update for presentation at the device, providing no response, or a combination thereof.

4. A method of claim 1, further comprising:
determining status information associated with retrieving the updated code, replacing the stored code, or a combination thereof; and
determining to transmit the status information to the application.

5. A method of claim 4, further comprising:
receiving an input for canceling the update;
determining to cancel the update based, at least in part, on the status information, the stored code, the executing code, or a combination thereof.

6. A method of claim 1, further comprising:
determining registration information of the application,
wherein at least one of determining whether the updated code is available, determining to retrieve the updated code, and determining to replace all or a portion of the stored code is based, at least in part, on the registration information.

7. A method of claim 1, further comprising:
determining resource location information of the updated code from the executing code, the stored code, an update service, an application provider, or a combination thereof,
wherein the retrieving of the updated code is based, at least in part, on the resource location information.

8. A method of claim 1, wherein the application is a web application or widget.

9. An apparatus comprising:
at least one processor; and
at least one memory including computer program code,
the at least one memory and the computer program code configured to, with the at least one processor, cause the apparatus to perform at least the following,
receive a request to update an application executing on a device, wherein execution of the application retrieves all or a portion of stored code associated with the application from a storage memory of the device and places the retrieved stored code as executing code in an execution memory of the device;
determine whether updated code corresponding to the application is available based, at least in part, on the request;
determine to retrieve the updated code if available; and
determine to replace all or a portion of the stored code with the updated code without affecting the executing code.

10. An apparatus of claim 9, wherein the application continues executing based, at least in part, on the executing code and determines a response to the update.

11. An apparatus of claim 10, wherein the response includes continuing to execute according to the executing code until a restart of the application, generating a notification of the update for presentation at the device, providing no response, or a combination thereof.

12. An apparatus of claim 9, wherein the apparatus is further caused to:
determine status information associated with retrieving the updated code, replacing the stored code, or a combination thereof; and
determine to transmit the status information to the application.

13. An apparatus of claim 12, wherein the apparatus is further caused to:
receive an input for canceling the update;
determine to cancel the update based, at least in part, on the status information, the stored code, the executing code, or a combination thereof.

14. An apparatus of claim 9, wherein the apparatus is further caused to:
determine registration information of the application,
wherein at least one of determining whether the updated code is available, determining to retrieve the updated code, and determining to replace all or a portion of the stored code is based, at least in part, on the registration information.

15. An apparatus of claim 9, wherein the apparatus is further caused to:
determine resource location information of the updated code from the executing code, the stored code, an update service, an application provider, or a combination thereof,
wherein the retrieving of the updated code is based, at least in part, on the resource location information.

16. An apparatus of claim 9, wherein the application is a web application or widget.

17. An apparatus of claim 9, wherein the apparatus is a mobile phone further comprising:
user interface circuitry and user interface software configured to facilitate user control of at least some functions of the mobile phone through use of a display and configured to respond to user input; and
a touch screen display and display circuitry configured to display at least a portion of a user interface of the mobile phone, the display and display circuitry configured to facilitate user control of at least some functions of the mobile phone and the simultaneous selection of the widgets.

18. A computer-readable storage medium carrying one or more sequences of one or more instructions which, when executed by one or more processors, cause the one or more processors to at least perform the following steps:
receiving a request to update an application executing on a device, wherein execution of the application retrieves all or a portion of stored code associated with the application from a storage memory of the device and places the retrieved stored code as executing code in an execution memory of the device;
determining whether updated code corresponding to the application is available based, at least in part, on the request;
determining to retrieve the updated code if available; and
determining to replace all or a portion of the stored code with the updated code without affecting the executing code.

19. A computer-readable storage medium of claim 18, wherein the application continues executing based, at least in part, on the executing code and determines a response to the update.

20. A computer-readable storage medium of claim 19, wherein the response includes continuing to execute according to the executing code until a restart of the application, generating a notification of the update for presentation at the device, providing no response, or a combination thereof.

21-42. (canceled)
